(19) United States
(12) Patent Application Publication
(10) Pub. No.: US 2012/0056994 A1
(43) Pub. Date: Mar. 8, 2012

(54) SINGLE-SHOT PHOTOMETRIC STEREO BY SPECTRAL MULTIPLEXING

(75) Inventor: Graham Leslie Fyffe, Los Angeles, CA (US)

(73) Assignee: UNIVERSITY OF SOUTHERN CALIFORNIA, Los Angeles, CA (US)

(21) Appl. No.: 13/221,354

(22) Filed: Aug. 30, 2011

Related U.S. Application Data
(60) Provisional application No. 61/402,443, filed on Aug. 30, 2010.

(51) Int. Cl. H04N 13/02; G06K 9/00

(52) U.S. Cl. 348/47; 382/162; 348/E13.074

(57) ABSTRACT

Single-shot photometric stereo techniques are disclosed in which chromaticity is assumed to be a variable. Scene illumination includes three or more spectrally distinct light sources. A scene image is taken with a camera system configured to measure five or more different bands, or channels, of the visible light spectrum. The light sources can include narrow-band colored LED lights, possibly combined with color filters to refine the spectral distributions. In each configuration, a beam splitter assembly is used to align two or more color cameras having different color filters placed over their lenses. By use of such techniques, a single multispectral photograph of a subject provides enough information to recover both the full-color reflectance and the surface normals on a per-pixel basis.

### RELATED APPLICATION

This application claims priority to and benefit of U.S. Provisional Patent Application Ser. No. 61/402,443 filed Aug. 30, 2010, Attorney Docket No. 028080-0601, and entitled “Single-Shot Photometric Stereo,” the entire content of which is incorporated herein by reference.

### BACKGROUND

Photometric stereo has been a powerful tool used for three-dimensional (3D) object acquisition techniques. Photometric stereo methods estimate surface orientation (for example surface normal vectors, or “normals”) by analyzing how a surface reflects light incident from multiple directions. Though it may not suitable for scenes with heavy occlusion or shadowing, photometric stereo has enjoyed widespread use.

In spectrally multiplexed photometric stereo, a scene is illuminated by multiple spectrally distinct light sources, and photographed by a camera system configured to capture multiple spectrally distinct color channels. The pixel intensity ck(x,y) for color channel k at pixel (x, y) can be given by the following:

$${c}_{k} ( x , y ) = {\sum }_{j} {l}_{j}^{T} n ( x , y ) \int {E}_{j} ( λ ) R ( x , y , λ ) {S}_{k} ( λ ) d λ \qquad ( EQ . 1 )$$

where 1j is the direction toward the jth light, λ represents wavelength, Ej (λ) is the spectral distribution of the jth light (presumed distant), n(x, y) and R(x, y, λ) are the surface normal and spectral distribution of the reflectance at pixel (x, y) (presumed Lambertian), and Sₖ (λ) is the spectral response of the camera sensor for the kth color channel. See, e.g., C. Hernandez and G. Vogiatzis, “Self-calibrating a Real-Time Monocular 3D Facial Capture System,” Proceedings International Symposium on 3D Data Processing, Visualization and Transmission (3DPVT), 2010. 1, 2, 5, 6, the entire content of which is incorporated herein by reference., Dropping the (x,y) indices, and considering discrete wavelengths instead of a continuous wavelength domain, EQ. 1 may be written in matrix form (with J lights, N discrete wavelengths, and K color channels) as:

c=Sdiag(r)ELn (EQ. 2)

where c=[c1, c2, . . . cK]^{T}, S(k,i)=Sk(λᵢ), r=[R(x, y, λ₁), R(x, y, λ₂), . . . , R(x, y, λ_{N})]^{T}, E(i, j)=Eⱼ(λᵢ), and L=[1₁, 1₂, . . . , 1_{J]}^{T}. This is equivalent to the following system of bilinear equations in r and n:

cₖ=r^{T}diag(sₖ)ELn, k=1, . . . ,K, (EQ. 3)

where sₖ=[S(k,1), S(k,2), . . . , S(k,N)]^{T}. The system of EQ. 3 is underdetermined, having N+3 degrees of freedom but only K equations, and therefore requires N+3−K additional constraints to regularize the system. In previous work with three color channels (K=3), the required N constraints are given implicitly by restricting the reflectance to have constant chromaticity. See, e.g., Hernandez and G. Vogiatzis. Self-calibrating a real-time monocular 3d facial capture system. In Proceedings International Symposium on 3D Data Processing, Visualization and Transmission (3DPVT), 2010. 1, 2, 5, 6; and, R. J. Woodham. Photometric method for determining surface orientation from multiple images. Optical Engineering, 19(1):139-144, 1980. 1, 2; the entire contents of both of which are incorporated herein by reference. Thus r is presumed constant (with a scalar albedo factor absorbed into n), reducing EQ. 3 to a system of linear equations.

Some photometric stereo techniques have used multiple photographs together with spectral multiplexing to capture multiple illumination conditions with fewer photographs, for various applications including photometric stereo for scenes with motion and color variation. Other techniques have improved on these results by explicitly modeling the effects of sensor crosstalk and changes in surface orientation due to subject motion. Still, all prior works that capture both color and normal rely on optical flow, and will fail if the scene contains enough motion or temporal inconsistency.

Several prior works have achieved single-shot photometric stereo, by employing spectral multiplexing, but are all subject to certain limitations on the surface coloration. All of these previous works for single-shot photometric stereo assume that the materials in the scene have constant chromaticity, meaning that the spectral distribution of the surface reflectance varies only by a uniform scale factor.

### SUMMARY

Single-shot photometric stereo techniques are disclosed in which chromaticity is assumed to be a variable. Scene illumination includes three or more spectrally distinct light sources. A scene image is taken with a camera system configured to measure five or more different bands, or channels, of the visible light spectrum.

Exemplary embodiments of a system include a six channel configuration, or a nine channel configuration, though other channel configurations are possible. The light sources can include white LED lights, filtered by three different color filters. The light sources can include narrow-band colored LED lights, possibly combined with color filters to refine the spectral distributions. In each configuration, a beam splitter assembly is used to align two or more color cameras having different color filters placed over their lenses, however the underlying method applies to any multi-channel camera system. For example, using specialized multi-channel cameras (whether multi-chip or multi-filter color arrays), or using cameras that are not aligned (in which case the system would rely on some method of finding pixel correspondences between cameras).

By use of such techniques, a single multispectral photograph of a subject provides enough information to recover both the full-color reflectance and the surface normals on a per-pixel basis.

### BRIEF DESCRIPTION OF THE DRAWINGS

The drawing figures depict one or more implementations in accord with the present teachings, by way of example only, not by way of limitation. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps. The drawings are not necessarily to scale, emphasis instead being placed on the principles of the disclosure. In the drawings:

FIG. 1 depicts a simplified schematic view of a system according to the present disclosure.

FIG. 2 is a schematic view of a configuration of three light sources according to the present disclosure.

FIG. 3 depicts a set of spectral distribution plots of a Dolby right eye filter and a Dolby left eye filter for a six-channel system according to the present disclosure.

FIG. 4 depicts a set of spectral distribution plots for three LED light sources for a six-channel system according to the present disclosure.

FIG. 5 depicts a set of spectral distribution plots of a three filters for a nine-channel system according to the present disclosure.

FIG. 6 depicts a set of color chart photographs used for calibration of exemplary embodiments.

FIG. 7 depicts a two-dimensional tabulation of the per-swatch reconstruction error over the photographs of FIG. 6 used for calibration.

FIG. 8 depicts a set of photographs and corresponding results for the color chart of FIG. 6, at various orientations.

FIG. 9 depicts recovered surface normals and reflectance of a toy fish.

FIG. 10 depicts a set of photographs and corresponding results for a human face, selected from a dynamic sequence.

FIG. 11 depicts a comparison to ground truth.

FIG. 12 depicts a set of photographs and corresponding recovered surface normals and reflectances for a human face, showing every tenth frame of a dynamic sequence.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Single-shot photometric stereo techniques, in which chromaticity is assumed to be a variable, are provided by scene illumination with three or more spectrally distinct light sources and image capture with five or more spectrally distinct color channels.

For the techniques of the present disclosure, the chromaticity or spectral distribution vector, r, of reflectance at a pixel is not restricted to constant chromaticity, is allowed to vary in some D-dimensional linear basis B, yielding the following for pixel intensity:

cₖ=\hat{r}^{T}B^{T}diag(sₖ)ELn, k=1, . . . ,K, (EQ. 4)

where \hat{r} is a D dimensional vector representing reflectance in the reduced basis (where like variables are indicated as for EQs. 1-3, described above). The reflectance basis, the sensor responses, and the illumination may be lumped into a single matrix per color channel Mₖ=B^{T}diag(sₖ)EL, yielding:

cₖ=\hat{r}^{T}Mₖn, k=1, . . . ,K, (EQ. 5)

The dimension of D can be selected D=K−2, so that the system of EQ. 5 has K+1 degrees of freedom and K equations; the final degree of freedom can be removed with ∥n∥=1. Robustness can be increased by lowering the dimensionality of the basis further (D<K−2), causing EQ. 5 to be overdetermined. Least squares solutions to overdetermined systems of bilinear equations can be obtained using a normalized iterative algorithm (e.g., see E. Bai and Y. Liu, “On the Least Squares Solutions of a System of Bilinear Equations,” in Proceedings of the 44th IEEE Conference on Decision and Control, and the European Control Conference, pages 1197-1202, Seville, 2005; the entire contents of which are incorporated herein by reference), which makes use of the normalization ∥n∥=1. Instead of requiring the first non-zero component of the normalized unknown to be positive, a modification can be made, requiring the z component of the surface normal (nz) to be positive, where z is defined to face toward the camera. The normalized iterative algorithm can operate as follows:

n[0,0,1]^{T}

for several iterations do

\hat{r}←[M₁n,M₂n, . . . ,M_{K}n]^{T}\[c₁,c₂, . . . ,c_{K}]^{T}

n←[M₁^{T}\hat{r},M₂^{T}\hat{r}, . . . ,M_{K}^{T}\hat{r}]^{T}\[c₁,c₂, . . . ,c_{K}]^{T}

n←sign(n_{z})n/∥n∥

end for

where A\b=arg minₓ∥Ax−b∥².

One practical implication of such a method is that capturing full-color RGB reflectance along with surface normals can utilize multi-spectral photography with at least five color channels, as RGB reflectance has three degrees of freedom, and surface normals have two. Consequently regarding apparatus, techniques according to the present disclosure can employ multi-spectral photography with at least five color channels. An exemplary embodiment can include a six-color-channel camera system that enables simultaneous capture of surface normals and three-color-channel reflectance, overdetermined by one degree of freedom for robustness, though other configurations are possible. For illumination, an illumination system or apparatus with three light sources, e.g., each a cluster of differently colored LED lights with filters, can be used to illuminate a scene including an object of interest. The illuminated scene is photographed with a camera system configured to measure six different channels of the visible light spectrum.

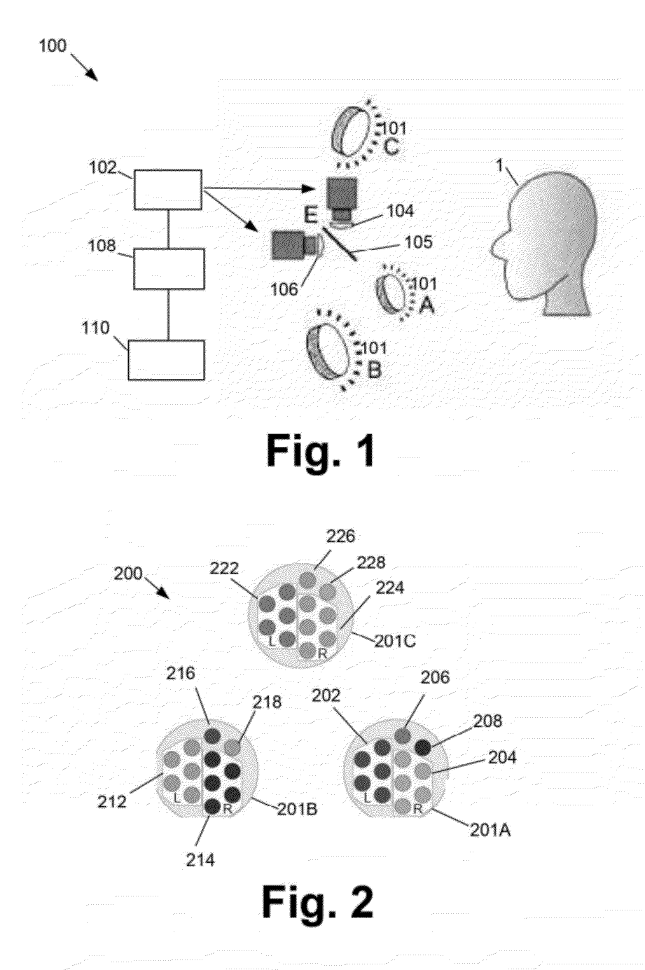

FIG. 1 depicts a simplified schematic view of an apparatus or system 100 according to the present disclosure. Three spectrally distinct light sources 101A-101C illuminate a subject 1, images of which can be recorded by a multi-spectral camera system referenced general by 102 and shown by example as 102E. The multi-spectral camera system 102 can obtain five or more spectral channels from the illuminated scene. This can be realized with different camera modalities. For example, two cameras as shown at 102E, or with one camera moved quickly to two positions, or with a stereo camera, such as the Fujifilm FinePix Real 3D W1/W3. In exemplary embodiments, the camera system can include two ordinary cameras filtered by Dolby “left eye” and “right eye” dichroic filters, and aligned using a beam splitter 105. The camera 102 can be connected and/or supply image data to a suitable memory unit 108, which can be connected to and/or accessible by a suitable processor 110. The processor 110 is one (or more) that can perform, carry out, and/or facilitate image processing techniques (in whole or in part) as described herein, e.g., single-shot photometric stereo by spectral multiplexing techniques.

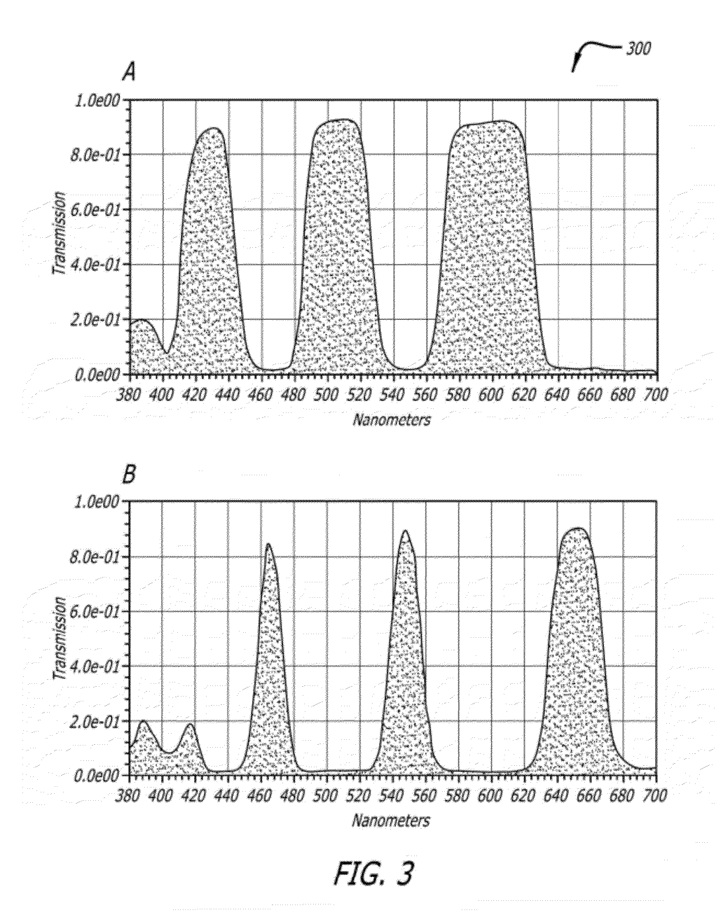

As shown in FIG. 1, to obtain multi-channel (e.g., six-channel) photographs, a beam splitter 105 can be used to align two ordinary color cameras 102E, and different filters, e.g., interference filters 104 and 106 placed over each camera lens. For example, a Dolby “left eye” dichroic filter can be placed over one camera lens, and a Dolby “right eye” dichroic filter can be placed over the other camera lens (e.g., as depicted in FIG. 1). Together, the two filters 104 and 106 can separate the visible spectrum into multiple bands, e.g., six non-overlapping bands e.g., as shown in FIG. 3 described below.

In exemplary embodiments, interference filters (dichromatic filters) can be used. The filters can divide the visible color spectrum into six narrow bands—two in the red region, two in the green region, and two in the blue region (e.g., referred to as R1, R2, G1, G2, B1 and B2 for the purposes of this description). The R1, G1 and B1 bands are used for one eye image, and R2, G2, B2 for the other eye. Dolby uses a form of this technology in its Dolby 3D theatres. Of course other suitable filters may be used. Examples include but are not limited to ColorCode 3D compliant filters, complimentary color filters, Inficolor (developed by TriOviz) compliant filters, linearly polarized filters, circularly polarized filters, and the like, See, e.g., U.S. Pat. No. 6,687,003, the entire content of which is incorporated herein by reference.

In exemplary embodiments, Grasshopper® cameras made commercially available by Point Grey Research, can be utilized for the camera system shown in FIG. 1, as they are easily synchronized to capture simultaneous photographs, and have a nearly linear intensity response curve. Suitable Grasshopper® camera models may include but are not limited to GRAS-03K2M/C, GRAS-0353M, GRAS-14SM/C, GRAS-14S5M/C, GRAS-20S4M/C, and GRAS-50S5M/C. The cameras themselves need not be modified, and standard color demosaicing algorithms may be used, since the data is captured as two separate three-channel photographs. Placing filters, e.g., dichroic filters like Dolby filters, in front of the lenses may mean that more than half of the light reaching the sensors is lost. Nevertheless, well-exposed, low-noise images may be obtained with the Grasshopper cameras in a real-time capture context. In applications requiring higher signal to noise ratios, three-chip color cameras could be employed, which have less inherent light loss than cameras based on Bayer color filter arrays.

FIG. 2 is a schematic view of a configuration 200 of three light sources according to the present disclosure. The configuration shown includes three light sources 201A-201C. For each light source, six different colors of LEDs can be arranged in clusters, some filtered by a Dolby “left eye” filter (L) or a Dolby “right eye” filter (R).

The LED clusters may be chosen such that each light source has approximately equal brightness of red+orange, green+cyan and blue+violet light, appearing roughly white to the human eye, and having roughly equal overall intensity when viewed through either Dolby filter. Such a technique may advantageously use somewhat brighter and/or more LEDs than traditional three-light photometric stereo, due to the light loss from the filters. For some applications, e.g., one subject to specular reflections, linear polarizing filters may be placed in front of the camera system and light sources to cancel out or mitigate specular reflections on the subject, and thus restore or facilitate since Lambertian reflectance. These filters may be omitted in applications where the subject reflectance is predominantly diffuse. The beam splitter, LED lights, Dolby filters, and polarizing filters shown are readily available and inexpensive, and any color cameras may be used so long as they can be synchronized to each other, making such a system relatively easy to reproduce. Of course while three different LED light sources are shown in FIG. 2, other types (e.g., incandescent lamps with filters) and/or configurations (four or more sources) of light sources may be used within the scope of the present disclosure.

In exemplary embodiments, the light sources 201A-201C include clusters of different combinations of violet, blue, cyan, green, orange and red LEDs. The spectral distributions of the violet, cyan and orange LEDs approximately coincide with the Dolby “right eye” filter, and the blue, green and red LEDs approximately coincide with the Dolby “left eye” filter. However, some of the LED colors overlap both the “left eye” and “right eye” Dolby filters, reducing any signal that may be encoded in the relationships between color channels. To eliminate this overlap, the LED clusters may be filtered with Dolby “left eye” (e.g., 202, 212, and 222) or “right eye” (e.g., 204, 214, and 224) filters as appropriate as shown. FIG. 2 also depicts an example of specific arrangement of colored LEDs used in an exemplary embodiment using three light sources, which are as follows:
Light source 201A including five red LEDs used with Dolby “left eye” filter 202, five cyan LEDs used with Dolby “right eye” filter 204, one blue LED 206, and one violet LED;
Light source 201B including five green LEDs used with Dolby “left eye” filter 212, five violet LEDs used with Dolby “right eye” filter 214, one red LED 216, and one orange LED 218; and
Light source 201C including five blue LEDs used with Dolby “left eye” filter 222, five orange LEDs used with Dolby “right eye” filter 224, one green LED 226, and one cyan LED 228.

FIG. 3 depicts a set 300 of spectral distribution plots of a Dolby “right eye” filter (A) and a Dolby “left eye” filter (B) as used to separate a photographed image into six non-overlapping bands or channels. The units are nanometers on the x-axis and transmission on the y-axis (in percentage). Non-overlapping bands are preferred however a degree of overlap may exist between the bands.

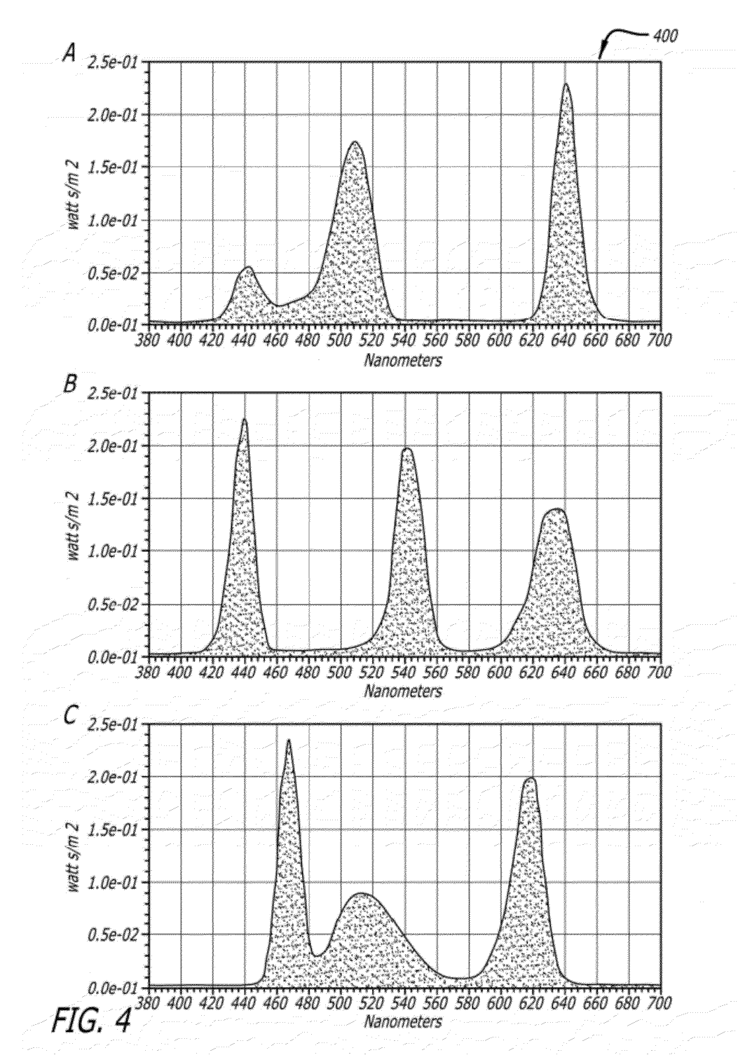

Light sources (such as those shown in FIG. 2) can provide three distinct spectral distributions, as shown in FIG. 4. FIG. 4 depicts a set 400 of spectral intensity distribution plots for three LED light sources for a six-channel system according to the present disclosure. The units are nanometers on the x-axis and intensity on the y-axis (in increments of 5.0×10⁻²).

For other embodiments, the light of the image (e.g., the scene illuminated with multi-spectral light) of interest may be split into more than two channels or images. For example, to obtain nine-channel photographs, a three-way beam splitter can be used to align three ordinary color cameras, with each camera having a different filter placed over its lens. The three color filters can be designed to separate the visible spectrum into nine non-overlapping (or substantially non-overlapping) bands.

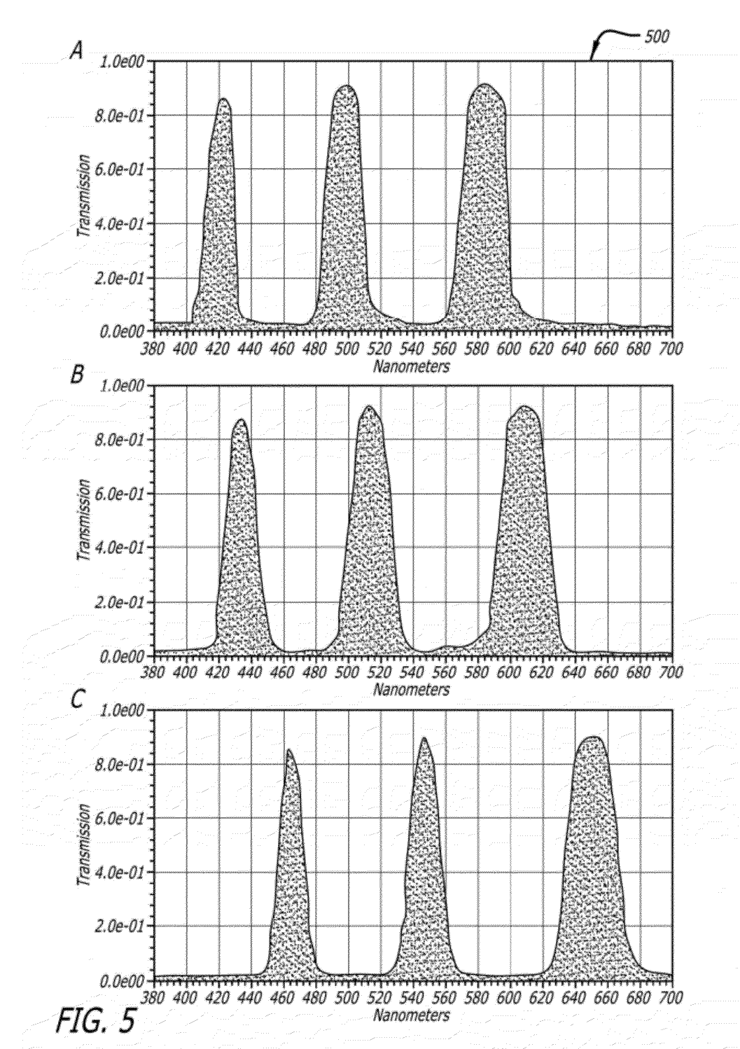

FIG. 5 depicts a set 500 of spectral distribution plots of a three filter configuration for a nine-channel system according to the present disclosure. In exemplary embodiments of a nine-channel system. The units are nanometers on the x-axis and transmission on the y-axis (in percentage). In exemplary embodiments, one of the filters can be identical to the Dolby “left eye” filter, and the other two filters may be manufactured using similar methods. The same three color filters can be used to filter the three light sources, making this a conceptually simpler design than a six channel configuration, since each camera effectively images the scene as illuminated by a single white-appearing light, in apparent full-color RGB. This configuration may provide surface normal discrimination on all color channels, yielding a configuration more robust to materials with saturated colors.

For calibration, the matrices Mₖ, k=1 . . . K in EQ. 5 may be obtained through the following procedure. Photographs can be taken of material samples with different known reflectance values \hat{r}ₜ and surface normals nₜ, satisfying:

c_{k,t}=\hat{r}ₜ^{T}Mₖnₜ, k=1, . . . ,K, t=1, . . . T, (EQ. 6)

where c_{k,t} is the kth color channel of measurement t. An estimation of Mₖ, where k=1 . . . K, may be made by the following:

$$〈 {M}_{k} 〉 = \vert \begin{matrix}〈 {\hat{r}}_{1} {n}_{1}^{T} 〉 / {‖ {\hat{r}}_{1} ‖}^{β} \\ 〈 {\hat{r}}_{2} {n}_{21}^{T} 〉 / {‖ {\hat{r}}_{2} ‖}^{β} \\ ⋮ \\ 〈 {\hat{r}}_{T} {n}_{T}^{T} 〉 / {‖ {\hat{r}}_{T} ‖}^{β}\end{matrix} \vert \backslash \vert \begin{matrix}{c}_{k , 1} / {‖ {\hat{r}}_{1} ‖}^{β} \\ {c}_{k , 2} / {‖ {\hat{r}}_{2} ‖}^{β} \\ ⋮ \\ {c}_{k , T} / {‖ {\hat{r}}_{T} ‖}^{β}\end{matrix} \vert \qquad ( EQ . 7 )$$

where (A) is the lexicographic concatenation of the columns of A, and βε(0 . . . 1) is a parameter to balance the importance of reflectance versus surface normal. In exemplary embodiments, a value of 0.5 is used for β. The choice of material samples used for calibration affects the accuracy of the method, since their spectral distributions effectively become a basis for recovered reflectance in a scene. Therefore, ideally the samples should be made from materials with similar spectral distributions as the materials in the scenes to be captured. If the materials in the scene are unknown in advance, an approximate calibration may be obtained with a set of generic materials. For the calibration in exemplary implemented embodiments, the twenty-four color swatches of a MacBeth ColorChecker™ chart were used, photographed at five known orientations (frontal, up, down, left and right). Linear sRGB color values can be used for the reflectance basis, which are readily available for the color chart swatches.

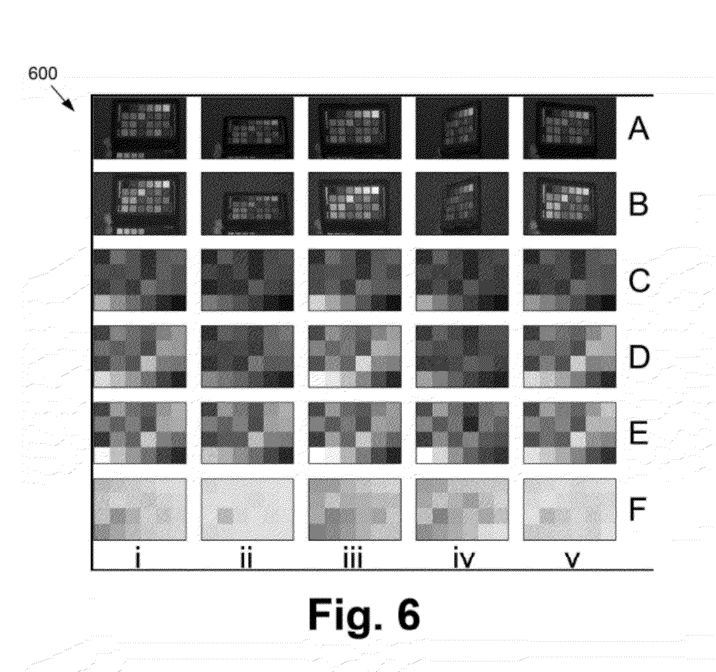

FIG. 6 shows a set 600 of photographs including the color chart photographs used for calibration, and the reconstructed reflectance and surface normals after calibration. The columns in the figure are the different orientations of the color chart: (i) frontal, (ii) up, (iii) down, (iv) left, and (v) right. Row A shows the first three color channels of input photographs. Row B shows the last three color channels of input photographs. Rows C and D show rows A and B sampled at chart swatch centers, averaged over 5×5 pixel windows. Row E shows the recovered reflectance. Row F shows the recovered surface normals.

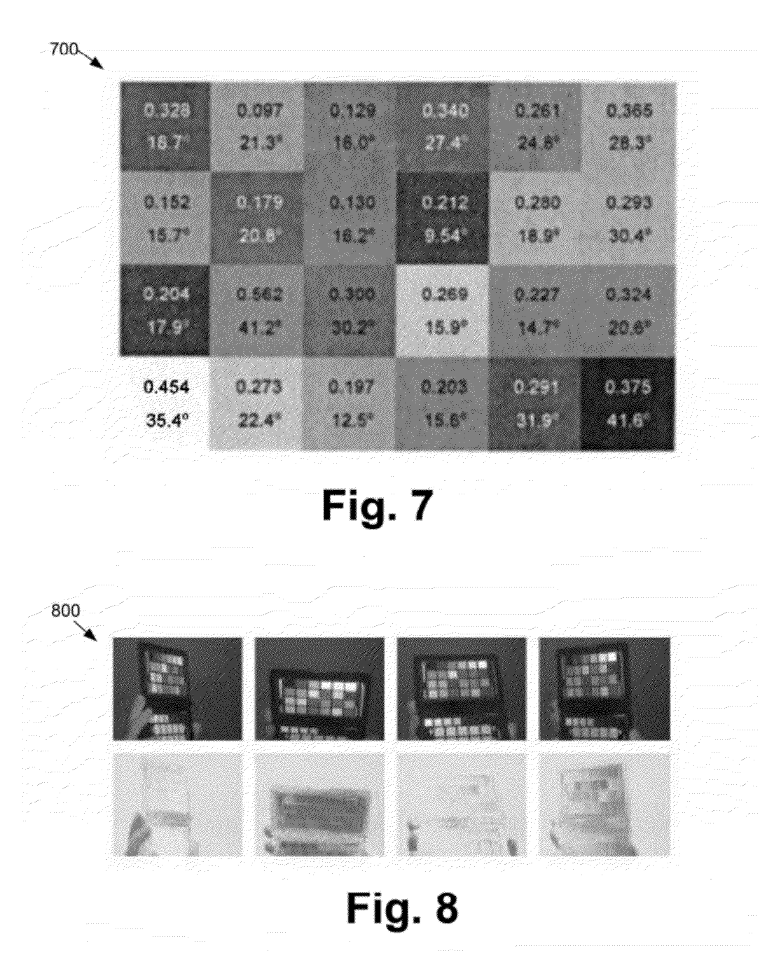

Using information from many materials and orientations for calibration can overconstrain the system of EQ. 7, which may result in some residual error. FIG. 7 shows a chart 700 tabulating the per-swatch reconstruction error over the photographs used for calibration in FIG. 6. The reconstruction errors shown are after calibration, per swatch. The top number represents relative root mean squared error (RMSE) of reflectance. The bottom number represents relative root mean squared error (RMSE) of surface normal, in degrees. Overall relative RMSE of reflectance is 0.288, and overall RMSE of surface normal is 24.3°.

For an exemplary embodiment, e.g., using the described six-color-channel camera system of FIGS. 1 and 3, and the linear sRGB reflectance basis with generic color-chart-based calibration, processing times were about one minute per frame on a single CPU using a straightforward implementation.

FIG. 8 depicts a set 800 of photographs and corresponding results for the color chart of FIG. 6, at various orientations. The recovered reflectance appeared to be stable, and the recovered surface normals extrapolated beyond the normals used in the calibration. The reconstruction errors tabulated in FIG. 7 indicate that a generic calibration results in significant bias in the reconstruction. This is believed to be primarily caused by variation in the reflectance spectral distributions of the different materials, which cannot be represented exactly by a three-dimensional basis.

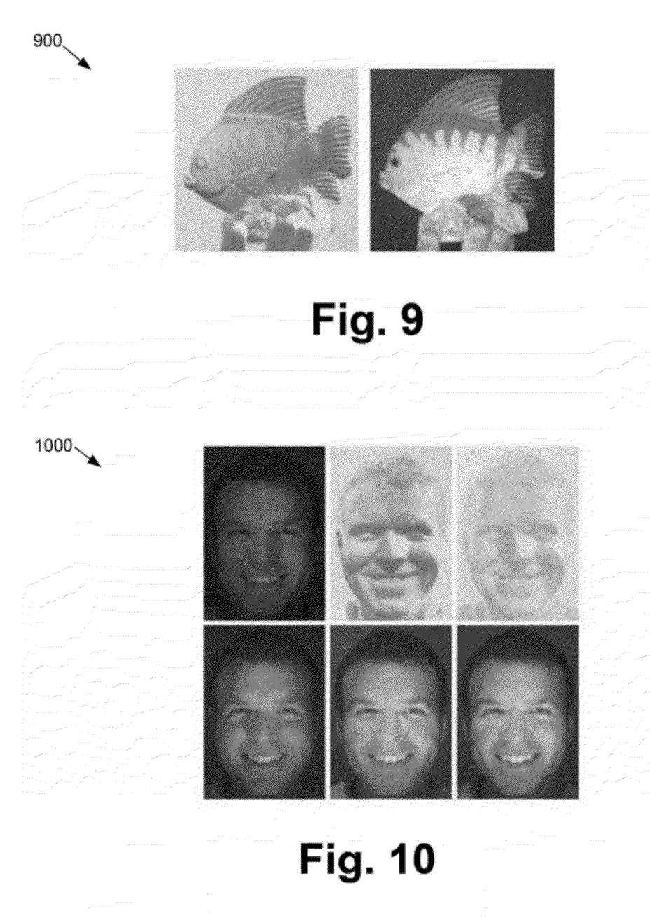

FIG. 9 depicts a set 900 of images showing recovered surface normals and reflectance of a toy fish. The above-noted bias is also noticeable in the results on the toy fish with highly saturated reflectance, shown in FIG. 9.

FIG. 10 depicts a set 1000 of photographs and corresponding results for a human face, selected from a dynamic sequence in which the subject is talking and looking around. A high-quality surface normal data set was obtained of the same subject in a similar pose using the method of Ma et al. to serve as ground truth. See W.-C. Ma, T. Hawkins, P. Peers, C.-F. Chabert, M. Weiss, and P. Debevec, “Rapid acquisition of specular and diffuse normal maps from polarized spherical gradient illumination,” in Rendering Techniques 2007: 18th Eurographics Symposium on Rendering, pages 183-194, June 2007. 1, 5, the entire contents of which are incorporated herein by reference. In the figure, the left top indicates the first three color channels of input; the left bottom indicates the last three color channels of input; the middle indicates the recovered surface normals and reflectance, with generic calibration; and the right indicates recovered surface normals and reflectance, scene-dependent calibration. The ground truth data was registered to one frame of the input data using optical flow, and a mask was drawn to separate the face from the background. It is noted that the eyes were also masked since they were closed in the ground truth data.

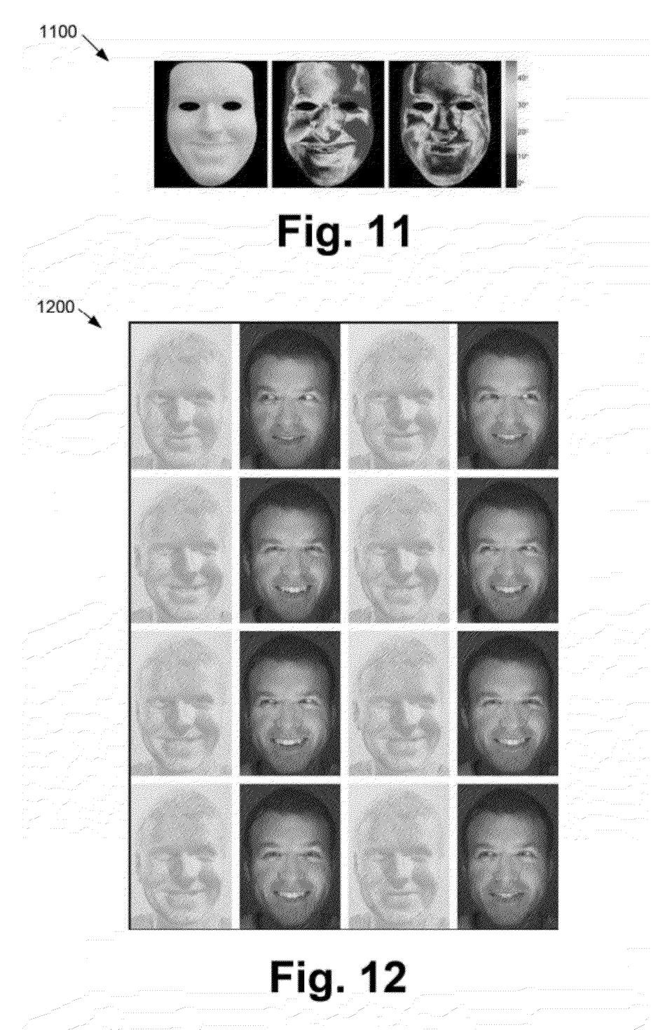

FIG. 11 depicts a set 1100 of images indicating a comparison of recovered reflectance to ground truth. FIG. 11 shows the root mean squared error (RMSE) of the recovered surface normals. The normals recovered using the generic calibration have significant bias. However, the technique used for the ground truth obtains good normals for faces using a one-dimensional basis, so a higher-dimensional basis should be sufficient given a scene-dependent calibration. To obtain an approximate scene-dependent calibration, the bias was modeled in the recovered normals with respect to the ground truth normals as a linear transform. The inverse transform was then applied to correct the normals, and finally the reflectance and corrected normals were input back into EQ. 7 to compute the scene-dependent calibration. All of these operations considered only those pixels within the masked region. This scene-dependent calibration was then to process the entire face sequence.

FIG. 12 depicts a set 1200 of photographs and corresponding recovered surface normals and reflectances for a human face, showing every tenth frame of a dynamic sequence. The color variation in the skin (e.g., of freckles, lips, etc.) was captured without corrupting the surface normals. Since no special handling of shadows was done, shadow regions around prominent features such as the nose exhibit artifacts, which are most noticeable in the recovered surface normals. Generally, photometric stereo approaches may advantageously take shadowing or visibility into account, or else suffer from such artifacts wherever some of the lights are not visible to the surface.

Accordingly, techniques for single-shot photometric stereo by spectral multiplexing are provided. The output that such techniques provide is a simultaneous per-pixel estimate of the surface normal and full-color reflectance. Such techniques may (i) be well suited to materials with varying color and texture, (ii) require no time-varying illumination, and, (iii) require no high-speed cameras. Such single-shot techniques may be applied to dynamic scenes without any need for optical flow.

Techniques described herein provide for spectrally multiplexed photometric stereo using more three color channels (e.g., five or more), allowing true simultaneous capture of per-pixel photometric normals and full color reflectance. This enables new applications of photometric stereo, in dynamic scenes with spatially varying color and enough motion that optical flow methods fail. Embodiments were implemented for six-color-channel and nine-color-channel apparatus using readily available parts. Results were shown demonstrating that the techniques of the present disclosure work for a variety of subjects, including a human face. For scenes with few distinct materials, such as a human face, bias in the reconstruction caused by spectral variation can be alleviated with scene-dependent calibration. For scenes with many distinct materials, bias may still persist even with scene-dependent calibration, and it may be desirable to increase the number of color channels captured by a camera system to combat this bias. Increasing the number of color channels from three to six allows systems and techniques according to the present disclosure to handle more distinct materials in a scene than previous methods. Finally, using brighter, more distant light sources and/or more light sources may increase the usable scene volume, and may improve the signal to noise ratio in the results.

Aspects of the methods of image processing outlined above may be embodied in programming. Program aspects of the technology may be thought of as “products” or “articles of manufacture” typically in the form of executable code and/or associated data that is carried on or embodied in a type of non-transitory machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer, processor, or device into another, for example, from a management server or host computer of the service provider into the computer platform of the application server that will perform the function of the push server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s), server(s), or the like, such as may be used to implement the push data service shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An image processing system for providing a simultaneous per-pixel estimate of the surface normal and full-color reflectance of an image, the system comprising:
a memory;
a processor connected to the memory; and
programming for execution by the processor, stored in the storage device, wherein execution of the programming by the processor configures the system to perform functions, including functions to:
from intensity data from a plurality of color channels corresponding to an image illuminated by light having a plurality of spectral distributions, provide an estimate of the pixel intensity for the image for each of the plurality of color channels;
wherein the estimate of pixel intensity comprises RGB reflectance having three degrees of freedom and surface normals having two degrees of freedom;
wherein the plurality of color channels comprise five or more color channels; and
wherein the plurality of spectral distributions comprise three or more different spectral distributions.

2. The system of claim 1, wherein the chromaticity varies in a D-dimensional linear basis B.

3. The system of claim 2, wherein the pixel intensity per channel is of the form: cₖ=\hat{r}^{T}MₖN, where k=1, . . . , K, \hat{r} is a D dimensional vector representing reflectance in the reduced basis, Mₖ is a per color channel matrix, and n is the surface normal.

4. The system of claim 3, wherein a normalized iterative algorithm is used to determine the surface normal n.

5. The system of claim 1, further comprising an optical camera system configured to record data from five or more optical channels from the image, and wherein the memory is configured to receive the data.

6. The system of claim 5, wherein the optical system comprises two cameras each with a filter.

7. The system of claim 5, wherein the optical camera system is configured to record data from six channels.

8. The system of claim 5, wherein the optical camera system is configured to record data from nine channels.

9. The system of claim 1, wherein each filter is configured to filter a desired polarity component for effecting a three dimensional image.

10. The system of claim 9, wherein the filters comprise left-eye and right-eye filters.

11. The system of claim 1, further comprising a light source configured to illuminate the image scene with light having three or more different spectral distributions.

12. The system of claim 11, wherein the light source comprises a plurality of light emitting diodes (LEDs).

13. The system of claim 12, wherein the plurality of LEDs further comprise a left-eye filter.

14. The system of claim 12, wherein the plurality of LEDs further comprise a right-eye filter.

15. An article of manufacture comprising:
a non-transitory machine-readable storage medium; and
executable program instructions embodied in the machine readable storage medium that when executed by a processor of a programmable computing device configures the programmable computing device to:
from intensity data from a plurality of color channels corresponding to an image illuminated by light having a plurality of spectral distributions, provide an estimate of the pixel intensity for the image for each of the plurality of color channels;
wherein the estimate of pixel intensity comprises RGB reflectance having three degrees of freedom and surface normals having two degrees of freedom;
wherein the plurality of color channels comprise five or more color channels; and
wherein the plurality of spectral distributions comprise three or more different spectral distributions.

16. The article of manufacture of claim 15, wherein the instructions provide that the chromaticity varies in a D-dimensional linear basis B.

17. The article of manufacture of claim 15, wherein the instructions provide that the pixel intensity per channel is of the form: cₖ=\hat{r}^{T}Mₖn, where k=1, . . . , K, \hat{r} is a D dimensional vector representing reflectance in the reduced basis, Mₖ is a per color channel matrix, and n is the surface normal.

18. The article of manufacture of claim 15, wherein the instructions provide that a normalized iterative algorithm is used to determine the surface normal n.

19. The article of manufacture of claim 15, wherein the instructions provide that the data is received from a video file.

20. The article of manufacture of claim 15, wherein the instructions provide that successive image data is received from a video file.
